(19) United States
(12) Patent Application Publication
(10) Pub. No.: US 2013/0251932 A1
(43) Pub. Date: Sep. 26, 2013

(54) Adhesive Patch

(71) Applicant: Patricia Boyko, Saskatoon SK (CA)

(72) Inventor: Patricia Boyko, Saskatoon SK (CA)

(21) Appl. No.: 13/788,340

(22) Filed: Mar. 7, 2013

(30) Foreign Application Priority Data
Mar. 7, 2012 (CA) 2770964

(51) Int. Cl. G09F 3/10

(52) U.S. Cl. CPC G09F 3/10
USPC 428/41.8

(57) ABSTRACT

A patch comprising a substrate layer and a backing layer, the layers provided with visual information, the substrate layer having an adhesive side for applying to surfaces after release from the backing layer. The substrate layer may be transparent with opaque visual information thereon, and the visual information may be reversed so that it appears in non-reversed orientation when viewed through the back of the transparent substrate layer.

The present invention relates to an adhesive patch, and more specifically, an adhesive patch that provides information in addition to a design on one side and information on a backing layer that is removed to attach the patch to an object.

### SUMMARY OF THE INVENTION

In one aspect, an adhesive patch having a substrate layer and a backing layer is provided. Adhesive can be provided on the second side of the substrate layer and covered with the backing layer. To use the adhesive patch, a user can remove the backing layer and stick the substrate layer to an object using the adhesive.

A design can be applied to the substrate layer along with first information. Second information can be provided on the backing layer so that the second information is visible when the backing layer is in place covering the adhesive on the substrate layer.

In another aspect, an adhesive patch is provided having a substrate layer and a backing layer. The substrate layer can be transparent and a design can be provided with first information so that the design and first information can be seen through the substrate layer when the substrate layer is applied to a transparent object, such as a window. Second information can be provided on the backing layer so that the second information is visible when the backing layer is used to cover the adhesive on the substrate layer.

### DESCRIPTION OF THE DRAWINGS

A preferred embodiment of the present invention is described below with reference to the accompanying figures, in which:

FIG. 1 is a front view of an adhesive patch;

FIG. 2 is a rear view of the adhesive patch shown in FIG. 1;

FIG. 3 is a side schematic illustration of the layers of the adhesive patch of FIG. 1;

FIG. 4 is a front view of the adhesive patch shown in FIG. 1 illustrating the separation of the adhesive layer of the first part from the substrate of the second part;

FIG. 5 is a front view of an adhesive patch;

FIG. 6 is a rear view of the adhesive patch shown in FIG. 5;

FIG. 7 is a side schematic illustration of the layers of the adhesive patch of FIG. 5; and

FIG. 8 is a front view of the adhesive patch with a backing layer removed.

### DETAILED DESCRIPTION OF THE ILLUSTRATED EMBODIMENTS

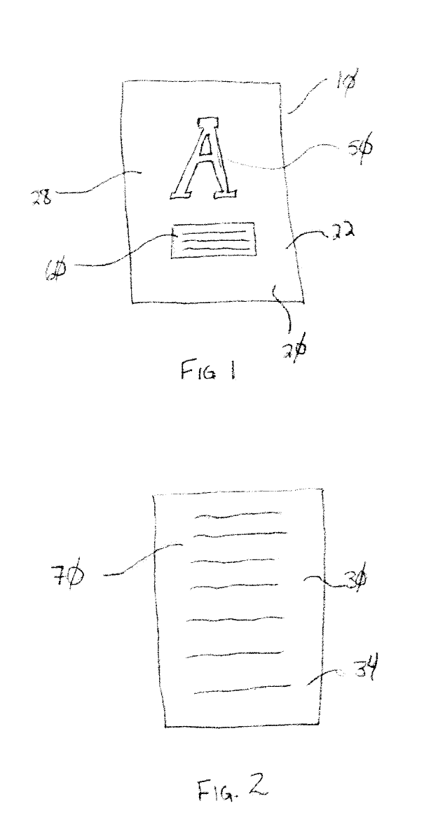

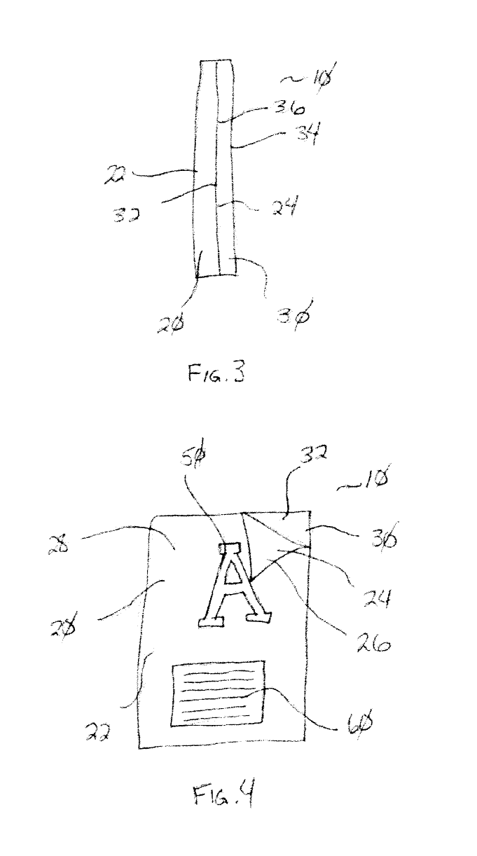

Referring to FIGS. 1 through 4, an adhesive patch 10 is shown. This adhesive patch 10 comprises a substrate layer 20 and a backing layer 30.

The substrate layer 20 can have a first side 22 where a design 50 is displayed on the first side 22 and a second side 24 wherein an adhesive 26 is applied to the second side 24 of the substrate layer 20. The backing layer 30 is initially applied over top of the adhesive 26 on the second side 24 of the substrate layer 20 so that the patch 10 can be carried around and stored before it is used. To attach the adhesive patch 10 to an object, a user can remove the backing layer 30 from the second side 24 of the substrate layer 20 by peeling the backing layer 30 away from the substrate layer 20 and exposing the adhesive 26 on the second side 24 of the substrate layer 20. With the adhesive 26 on the second side 24 of the substrate layer 20 exposed, the user can press the second side 24 of the substrate layer 20 against and object with a reasonably smooth surface, such as a bag, window, books, binders, luggage, mirrors, day timers, garbage cans, paper, clothing, windows, etc., causing the substrate layer 20 to adhere to the surface of the object with the design 50 facing outwards from the first side 22 of the substrate layer 20.

The design 50 can be provided on the substrate layer 20 so that the design 50 is visible when the substrate layer 20 is stuck to an object. The design 50 could be a cartoon, logo or some other ornamental element. In one aspect, the design 50 can be a logo, photo, mascot, picture or other image that is related to a first entity. This first entity can be a company, business, sports team, school, etc and the design 50 will therefore by the logo, etc. of that company, business, sports team, school, etc.

In another embodiment, the design 50 could be related to an event.

In addition to the design 50, first information 60 can be provided visible on the first side 22 of the substrate layer 20. In one aspect, this first information 60 can be related to the first entity to which the design 50 is related. For example, the first information 60 could be the name and any other information regarding the first entity and the design 50 could be the logo of the first entity.

In another aspect, the first information 60 could be related to a second entity. This second entity could be a company, business, etc. that differs from the first entity. This second entity could be a sponsor of the first entity and the first information 60 could be used to inform a viewer of this fact. In this manner, the adhesive patch 10 can serve a dual marketing function informing a view of a first entity by the design 50 and a sponsorship of that first entity by a second entity with the first information 60.

If the design 50 is related to a specific event, the first information 60 could be used to indicate an entity that is sponsoring the event.

In one aspect, the substrate layer 20 can be have a generally transparent portion 28 that surrounds the design 50 and the design 50 would typically be opaque. In this manner, when the substrate layer 20 is applied to an object, a person can see through the transparent portion 28 to the surface of the object and it may not be that apparent where the outer edges of the substrate layer 20 are. However, the edges of the design 50 will be clearly visible.

The adhesive on the adhesive 26 applied to the second side 24 of the substrate layer 20 could be transparent. In this manner, when the substrate 20 is applied to an object, a person can see through the transparent portion 28 of the substrate layer 20, through the transparent adhesive 26 on the second side 24 of the substrate layer 20 to the object below.

The backing layer 30 can have a first side 32 and a second side 34. Typically, the backing layer 30 will have substantially the same area as the substrate layer 20 so that when the backing layer 30 is used to cover the adhesive 26 on the second side 24 of the substrate layer 20, the backing layer 30 will substantially cover the second side 24 of the backing layer 30.

Second information 70 can be provided on the second side 34 of the backing layer 30. This second information 70 can be printed or otherwise and visible to a person when the backing layer 30 is in place over the adhesive 26 on the second side 24 of the substrate 20. In this manner, the second information 70 is visible to a person before the backing layer 30 is removed from the substrate layer 20 and the substrate layer 20 is stuck to an object.

This second information 70 on the backing layer 30 could be related to either the first entity and the first design 50 or the second entity and the first information 60 on the substrate layer 20 of the adhesive patch 10. In one aspect, the second information 70 on the backing layer 30 can be contextually related to the design 50 on the first side 22 of the substrate layer 20. In a another aspect, the second information 70 can be related to the first information 60 on the first side 22 of the substrate layer 20. The second information 70 could be information about the first entity if it is related to the design 50 or information about the second entity if it is related to the first information 60. This second information 70 does not just have to take the form of information about the entity, the second information 70 could be a schedule, coupon, motto, map, etc.

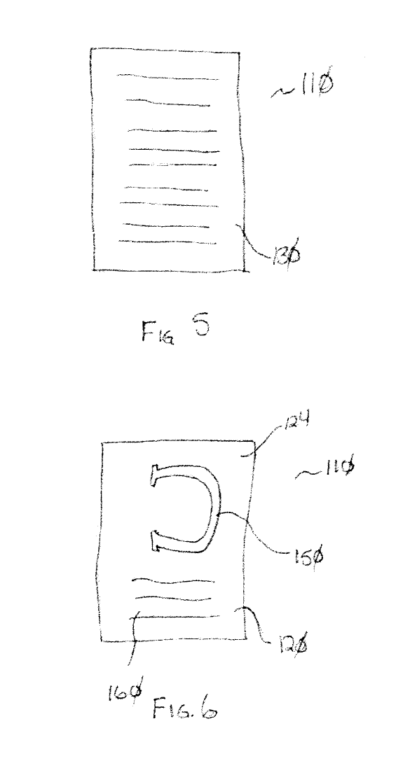

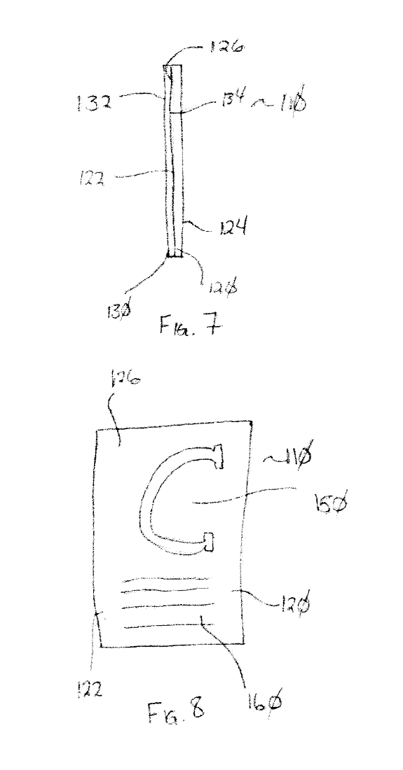

Referring to FIGS. 5 through 8, a second embodiment of an adhesive patch 110 is shown. Like adhesive path 10 shown in FIGS. 1 through 4, adhesive patch 110 comprises a substrate layer 120 and a backing layer 130. However, with the adhesive patch 110 a design 150 is applied to a second side 124 of the substrate layer 120 and the backing layer 130 is applied over adhesive 126 on the first side 122 of the substrate layer 120. In this manner, the backing layer 130 can be peeled off the first side 122 of the substrate layer 120 and the substrate layer 120 and the first side 122 of the substrate layer 120 applied to a transparent object such as a window, etc. The design 150 will show through the substrate layer 120 and the object, allowing a viewer on the other side of the object to see the design 150. As can be seen in FIG. 6, the design 150 is backwards because it will be showing through the first side 122 of the substrate layer 120 when the substrate layer 120 is applied to a clear object, such as a window. FIG. 8 shows the substrate layer 120 from the front when the backing layer 130 has been removed.

Referring again to FIGS. 5 through 8, the design 150 can be applied to the second side 124 of the substrate layer 120. The substrate layer 120 can be transparent with the design 150 facing the substrate layer 120. In this manner, when the backing layer 130 is removed, the design 150 can be viewed through the transparent substrate layer 120. First information 160, similar to first information 60 used for the adhesive patch 10, can also be provided on the second side 124 of the substrate layer 120.

Adhesive 126 which is also transparent can be applied to the first side 122 of the substrate layer 120.

The backing layer 130 can have a first side 132 and a second side 134. Typically, the backing layer 130 will have substantially the same area as the substrate layer 120 so that when the backing layer 130 is used to cover the adhesive 126 on the first side 122 of the substrate layer 120, the backing layer 130 will substantially cover the first side 122 of the backing layer 130.

Second information 170, similar to the second information 70 for the adhesive patch 10, can be provided on the first side 132 of the backing layer 130.

It is within the scope of this disclosure for the adhesive patch to have shapes other than rectangular, such as, for example, square, circular, triangular, oval, trapezoidal, as well as all other irregular shapes.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A patch comprising:
a substrate layer having first and second sides, the first side of the substrate layer being provided with first visual information, the second side of the substrate layer being provided with an adhesive; and
a backing layer having first and second sides, the first side of the backing layer being configured to releasably adhere to the adhesive;
wherein when the first side of the backing layer is released from the adhesive on the second side of the substrate layer the adhesive on the second side of the substrate layer can be applied to a surface such that the substrate layer is adhered to the surface.

2. The patch of claim 1 wherein the second side of the backing layer is provided with second visual information.

3. The patch of claim 1 wherein the first visual information is selected from the group consisting of textual and design elements.

4. The patch of claim 2 wherein the second visual information is selected from the group consisting of textual and design elements.

5. The patch of any one of claim 3 or 4 wherein the design elements are selected from the group consisting of logos, cartoons, photographs, pictures and images.

6. The patch of any one of claim 3 or 4 wherein the textual elements are selected from the group consisting of event information, sponsor information, schedules, coupons, mottos and maps.

7. The patch of claim 1 wherein the surface is of an object selected from the group consisting of a bag, window, book, binder, luggage, mirror, day timer, garbage can, paper and clothing.

8. The patch of claim 1 wherein the substrate layer and the backing layer are of a desired boundary form selected from the group consisting of rectangular, square, circular, triangular, oval, trapezoidal and irregular.

9. The patch of claim 1 wherein the substrate layer is at least partially transparent and the first visual information provided thereon is generally opaque.

10. The patch of claim 9 wherein the substrate layer is entirely transparent and the first visual information provided thereon is generally opaque.

11. The patch of any one of claim 9 or 10 wherein the first visual information is provided on the first side of the substrate layer in a reversed orientation, such that when viewing the first visual information through the substrate layer from the second side of the substrate layer the first visual information appears in a non-reversed orientation.

12. The patch of claim 11 wherein the surface is a transparent surface, such that when the substrate layer is adhered to the surface, the first visual information appears in a non-reversed orientation when viewed through the transparent surface and the substrate layer.
